(19) United States
(12) Patent Application Publication
(10) Pub. No.: US 2026/0178925 A1
(43) Pub. Date: Jun. 25, 2026

(54) AGENTIC AI SYSTEMS AND METHODS OF CONTEXT DISAMBIGUATION

(71) Applicant: Arm Limited, Cambridge (GB)

(72) Inventors: Remy Pottier, Grenoble (FR); Subbayya Chowdary Yanamadala, Dallas, TX (US); Nicholas John Cook, Bath (GB); Diya Soubra, Nice (FR)

(21) Appl. No.: 18/990,502

(22) Filed: Dec. 20, 2024

(51) Int. Cl. G06N 3/092

(52) U.S. Cl. CPC G06N 3/092

(57) ABSTRACT

The present disclosure relates to a system for constructing global context from a plurality of artificial intelligence, AI, agents, comprising: a local context coordinator to communicate with the plurality of AI agents, to receive from one or more of the plurality of AI agents a current observed state representative of a current local environment of each AI agent, and to normalise the current observed state to a common form; a conflict handler to receive the current normalised observed states from the local context coordinator and generate a set of conditions based on the current normalised observed states; and a global context generator to receive the set of conditions and generate an integrated context representative of a global environment comprising the respective current local environment of the plurality of AI agents.

### FIELD

The present technology relates generally to agentic artificial intelligence systems. More particularly, the present technology relates to context-aware multi-agent systems.

### BACKGROUND

In recent years, the use of artificial intelligence (AI) has become more and more widespread. Most recent development includes generative AI and agentic AI, which have gained much public interests.

Generative AI uses human input and guidance to determine the context and goal for an output, and generates new content across various formats, including text, images, music, and computer program code.

Agentic AI refers to autonomous AI agents that can analyse situations, formulate strategies, and execute actions to achieve specific goals with minimal human supervision. Agentic AI is able to achieve near-human cognition in many areas by employing a combination of AI techniques, such as large language models (LLMs), machine learning algorithms (MLAs), deep learning, reinforcement learning, etc. For example, LLMs may be employed to allow autonomous systems to understand and respond to natural language commands, MLAs may enable such systems to analyse data and identify patterns, reinforcement learning techniques may enable such systems to learn from their actions and improve their decision making over time.

In a system with multiple AI agents, each AI agent may perceive only a limited portion of a larger global (physical or information) environment. Thus, each AI agent may hold a piece of local context that may be shared amongst the multiple AI agents to construct a global context. Herein, AI agents may refer to physically separate agents such as individual devices, or they may refer to software agents that may be present in the same device or across more than one device. Examples of such systems may include multiple autonomously driven vehicles transporting goods in a warehouse each with a limited view of the warehouse, or multiple apps on a smart device each with a limited set of data concerning the user.

However, such context sharing amongst multiple AI agents may sometimes be ineffective if, for example, one or more AI agents share irrelevant or inaccurate context, then the irrelevant or inaccurate context may introduce noise to the global context, reducing the performance of the system.

There is, therefore, scope for improving context sharing in a multi-agent system, in which the environment may be dynamically changing under uncertain rules or patterns.

### BRIEF DESCRIPTION OF THE DRAWINGS

Embodiments will now be described, with reference to the accompanying drawings, in which:

FIG. 1 shows schematically an exemplary multi-agent system according to an embodiment;

FIG. 2 shows schematically an exemplary data flow of an embodiment of a conflict handler; and

FIG. 3 shows a flow diagram of an exemplary method of consolidating local context into global context.

### DETAILED DESCRIPTION

An aspect of the present technology provides a system for constructing global context from a plurality of artificial intelligence, AI, agents, comprising: a local context coordinator to communicate with the plurality of AI agents, to receive from one or more of the plurality of AI agents a current observed state representative of a current local environment of each AI agent, and to normalise the current observed state to a common form; a conflict handler to receive the current normalised observed states from the local context coordinator and generate a set of conditions based on the current normalised observed states; and a global context generator to receive the set of conditions and generate an integrated context representative of a global environment comprising the respective current local environment of the plurality of AI agents.

According to embodiments of the present technology, a conflict handler is provided, which receives normalised observed states representative of the local context of respective AI agents from a local context coordinator, and generates a set of conditions for a global context generator to generate a global context for the multi-agent system. Herein, an observed state may refer to an observation or perception made by an AI agent, such as e.g. various forms of sensor data, data from various databases, inputs from various digital interfaces, etc. Individual AI agents may have different ontology and by the local context coordinator normalising the observed states received from the AI agents, the conflict handler may process and score the observed states of different AI agents in a standardised way to facilitate context understanding. Using the normalised observed states, the conflict handler generates the set of conditions which the global context generator uses as input to generate the global context. Thus, the conflict handler facilitates a centralised assessment or evaluation of the local context observed by different AI agents irrespective of ontology. In doing so, it is possible to generate global context from local context observed/perceived by individual AI agents with reduced (or altogether without) conflict.

In some embodiments, the conflict handler may be configured to generate the set of conditions based on a divergence between the current normalised observed states and respective previous normalised observed states. The conflict handler may be configured to determine, e.g. for each AI agent, a divergence between the current observed state and a previous (e.g. immediately preceding) observed state. Such a divergence measure gives an indication of how fast the context as observed/perceived by the AI agent is transitioning, and the context divergence of individual AI agents may be compared to identify any anomalies.

In some embodiments, the conflict handler may be configured to identify one or more AI agents with high divergence between the current normalised observed states and respective previous normalised observed states.

In some embodiments, at least one AI agent may be configured to output a current predicted state of the respective local environment based on a previous observed state, the local context coordinator may be configured to normalise the current predicted state from the at least one AI agent, and the conflict handler may be configured to generate the set of conditions based on a divergence between the current normalised observed state and the current normalised predicted state of the at least one AI agent. Some of the AI agents may have the capability to output a prediction of the current state based on one or more previously observed state. Through the conflict handler determining for such an AI agent a divergence between the current observed state and the current predicted state, it is possible to obtain an indication of how fast the context as observed/perceived by the AI agent is predicted to be transitioning, and the predicted context divergence of individual AI agents may be compared to identify any anomalies.

In some embodiments, the conflict handler may be configured to identify one or more AI agents with high divergence between the current normalised observed states and respective current normalised predicted states.

In some embodiments, the conflict handler may be configured to generate the set of conditions based on a divergence between the current normalised predicted states and respective previous normalised predicted states.

In some embodiments, the conflict handler may be configured to identify one or more AI agents with high divergence between the current normalised predicted states and respective previous normalised predicted states.

In some embodiments, the conflict handler may be configured to receive metadata from one or more AI agents and generate the set of conditions based on the metadata respective of each AI agent. In addition to data observed/perceived by an AI agent, it may sometimes be useful to consider the metadata generated for the observed data and/or for the AI agent itself.

The metadata of an AI agent may, for example, indicate the reliability of the observed data, the trustworthiness and/or the capability of the AI agent. Thus, in some embodiments, the conflict handler may be configured to use the metadata respective of an AI agent to determine a weight with respect to a normalised observed state received from the AI agent. The weight given to a particular observed state, or an observed state received from a particular AI agent, may for example be proportionate to the reliability of the data and/or the trustworthiness or capability of the AI agent.

The metadata of two (or more) AI agents may indicate that there are (or should be) some overlaps in the local context observed/perceived by the two AI agents. For example, the metadata of the two AI agents may indicate that the two AI agents are in close proximity, or obtain data from the same database, etc. Thus, in some embodiments, the conflict handler may be configured to use the current normalised observed state of a first AI agent, the metadata of the first AI agent, and the metadata of a second AI agent, to validate the current normalised observed state of the second AI agent.

In some embodiments, the metadata may comprise a location of the AI agent, a capability of the AI agent, one or more hardware characteristics, one or more software characteristics, or a combination thereof.

Equipped with the global context, the global context generator can be in a better position for decision-making compared to individual AI agents, and may be able to formulate a plan of action for one or more AI agents that is better suited according to the global context compared to individual decisions made by individual AI agents. Thus, in some embodiments, the global context generator may be configured to use the generated integrated context to output an instruction to at least one of the plurality of AI agents to perform an action.

In some embodiments, the global context generator may be an in-context learning computation model and the set of conditions comprises one or more input prompts. For example, such an in-context learning computation model may include a large language model (LLM).

Another aspect of the present technology provides a computer-implemented method of constructing global context for a system comprising a plurality of artificial intelligence, AI, agents, the method comprising: receiving, by a local context coordinator, from one or more of the plurality of AI agents a current observed state representative of a current local environment of each AI agent; normalising, by the local context coordinator, the received current observed state to a common form; receiving, by a conflict handler, the current normalised observed states from the local context coordinator; generating, by the conflict handler, a set of conditions based on the current normalised observed states; receiving, by a global context generator, the set of conditions; and generating, by the global context generator, an integrated context representative of a global environment comprising the respective current local environment of the plurality of AI agents.

In some embodiments, generating a set of conditions may comprise the conflict handler determining a divergence between the current normalised observed states and respective previous normalised observed states. In some embodiments, the method may further comprise: receiving, by the local context coordinator, from each AI agent a current predicted state of the respective local environment generated based on a previous observed state; normalising, by the local context coordinator, the current predicted state from each AI agent; and generating, by the conflict handler, the set of conditions based on a divergence between the current normalised observed states and respective current normalised predicted states.

In some embodiments, generating a set of conditions may comprise the conflict handler determining a divergence between the current normalised predicted states and respective previous normalised predicted states.

In some embodiments, the method may further comprise: receiving, by the conflict handler, metadata from one or more AI agents; and generating, by the conflict handler, the set of conditions based on the metadata respective of each AI agent.

In some embodiments, the method may further comprise determining, by the conflict handler, a weight with respect to a normalised observed state received from an AI agent by using the metadata respective of the AI agent.

In some embodiments, the method may further comprise validating, by the conflict handler, the current normalised observed state of a second AI agent by using the current normalised observed state of a first AI agent, the metadata of the first AI agent, and the metadata of the second AI agent.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

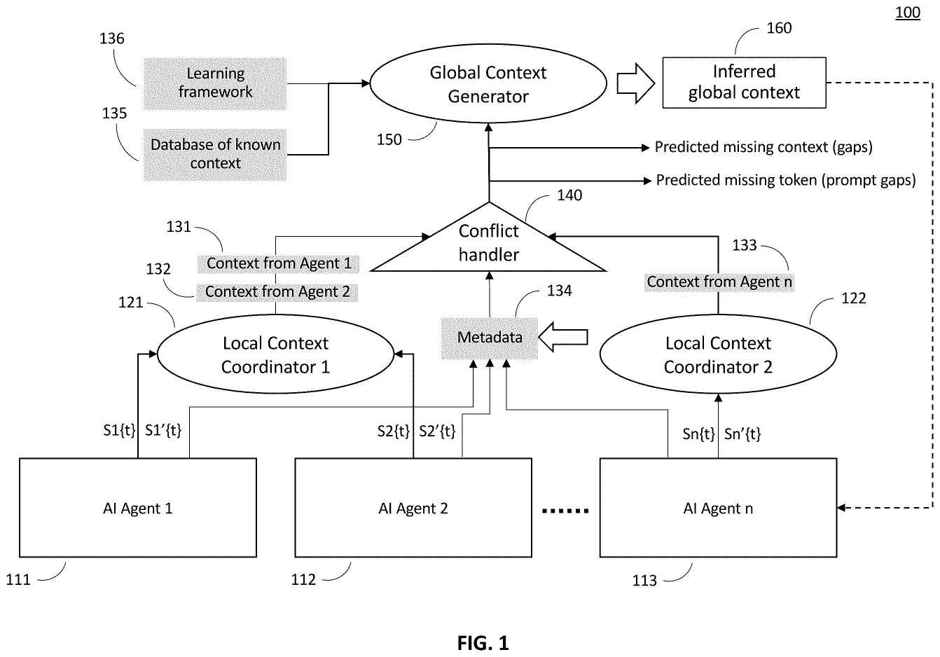

FIG. 1 shows schematically an exemplary multi-agent system 100 according to an embodiment. The system 100 comprises a plurality of AI agents 111, 112, 113. In an example, an AI agent may process a local environment at an instant t by (1) gathering and processing data from various sources, such as sensors, databases and digital interfaces, e.g. extracting meaningful features, recognizing objects and/or identifying relevant entities in the environment; (2) understanding tasks and generating solutions through an orchestrator/coordinator/reasoning engine and coordinating specialized models for specific functions such as content creation, vision processing and/or recommendation systems; (3) executing the tasks formulated e.g. by integrating with external tools and software via application programming interfaces; and (4) learning from the data generated from the process through a feedback loop to enhance the models.

The system 100 further comprises local context coordinators 121, 122 which communicate with the plurality of AI agents 111, 112, 113. In some embodiments, the system 100 may comprise one or more, or all, of the plurality of AI agents 111, 112, 113. Each local context coordinator may be arranged to communicate with one or more, or all, of the plurality of AI agents, according to capability and as desired. In the present example, two local context coordinators 121, 122 are shown, wherein local context coordinator 1 121 is arranged to communicate with AI agent 1 111 and AI agent 2 112, while the local context coordinator 2 122 is arranged to communicate with AI agent n 113. However, in other embodiments, a single local context coordinator may be provided to communicate with all of the plurality of AI agents of the system, or more than two local context coordinators may be provided each to communicate with one or more AI agents.

The local context coordinator 121 receives observed state S1{t} from AI agent 111 and observed state S2{t} from AI agent 112, and the local context coordinator 122 receives observed state Sn{t} from AI agent 113, at a given instant (time) t. An observed state S{t} at a given instant t may be any observable or measurable variable as observed or perceived by an AI agent, such as a location or position of an object, a classification of an object, data concerning a local environment including sensor data such as temperature, audio data, infrastructure, etc., data concerning a user (e.g. when the AI agent is a device or is installed as one of many apps on a device) including sensor data such as heartrate, body temperature, bank balance, etc. The local context coordinators 121, 122 are configured to normalize the received observed states S1{t}, S2{t} and Sn{t} to a common form, and then output the normalized observed states S1{t}, S2{t} and Sn{t} identified as local context respectively from AI agents 111, 112, 113 to a conflict handler 140.

The local context coordinator 121 receives predicted state S1′{t} from AI agent 111 and predicted state S2′{t} from AI agent 112, and the local context coordinator 122 receives predicted state Sn′{t} from AI agent 113, at the given instant (time) t. A predicted state S′{t} at a given instant t is a state predicted, e.g. by an appropriate predictor module of an AI agent, based on an earlier state, e.g. a state S{t−1} at an instant t−1 immediately prior to instant t. The local context coordinators 121, 122 are configured to similarly normalize the received predicted states S1′{t}, S2″ {t} and Sn′{t} to the common form, and then output the normalized predicted states S1′{t}, S2′{t} and Sn′{t} identified as predicted local context respectively from AI agents 111, 112, 113 to the conflict handler 140.

The local context coordinators 121, 122 may, for example, be an in-context learning computation model such as a large language model (LLM). The plurality of AI agents 111, 112, 113 may be any suitable agentic AI. For example, one or more AI agents may implement Joint Embedding Predictive Architecture (JEPA), which may comprise various elements: input, which takes a pair of related inputs, e.g. sequential frames of a video (a current frame x and a subsequent frame y); encoder, which transforms the inputs into abstract representations (Sₓ and S_{y}) that capture features of the inputs; predictor module, which is trained to predict the abstract representation of the subsequent frame, S_{y}, based on the abstract representation of the current frame, Sₓ.

The local context coordinator 121 processes and normalizes the observed state S1{t} and the predicted state S1′{t} from AI agent 111 and the observed state S2{t} and the predicted state S2′{t} from AI agent 112 into a common form, and outputs the normalized observed and predicted states as context from Agent 1 131 and context from Agent 2 132 to a conflict handler 140. Similarly, the local context coordinator 122 processes and normalizes the observed state Sn{t} and the predicted state Sn′{t} from AI agent 113 into the common form, and outputs the normalized observed and predicted states as context from Agent n 133 to the conflict handler 140. For example, the local context coordinators 121, 122 may implement AI cognition to understand causal relationships e.g. arising from the actions of the AI agents, objects and other entities, for example by leveraging knowledge graphs and a range of functions.

Moreover, the conflict handler 140 receives metadata 134 from the AI agents 111, 112, 113, such as AI agent location, capabilities, hardware and/or software characteristics, and/or one or more matrices of cross-agent knowledge, and other data such as database(s) of known context 135 and/or one or more learning models 136. In addition, or alternatively, the conflict handler 140 may autonomously search for metadata related to one or more individual AI agents by searching for inputs in user manuals or other device-related available documentations that are publicly available or provided by third parties e.g. to obtain information on device capability (may have to translate from Chinese UM to English or working language) so as to augment the one or more individual agents inputs with external sources of metadata. In some cases, the conflict handler 140 may be required to translate these external sources of metadata, e.g. a Chinese language user manual may be translated to English or another working language. The conflict handler 140 may be defaulted to search for such external sources of metadata, or it may be configured to only search external sources when metadata for a given AI agent cannot be directly obtained from the AI agent. For example, there may be circumstances when a given device is not able to share metadata directly, e.g. if the device is a low-end device and/or the device does not have the intelligence (e.g. due to versioning) to enable such sharing of metadata.

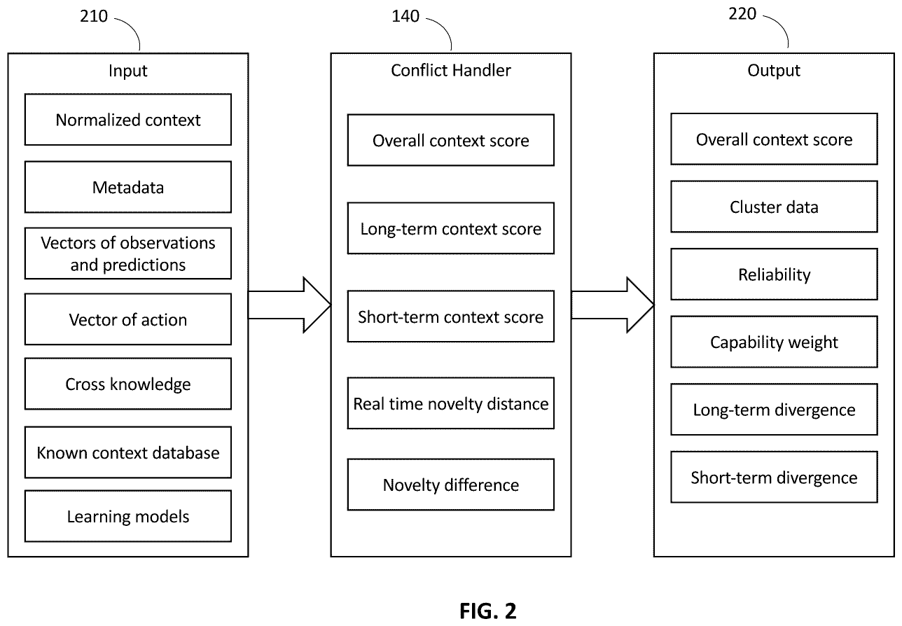

The conflict handler 140 processes the received data (described further below with reference to FIG. 2) to output a set of conditions that is used as inputs by a global context generator 150 to generate an inferred global context 160 for the global environment that integrates and consolidates the local context transmitted from the respective AI agents 111, 112, 113. Moreover, the global context generator 150 may: output the inferred global context to a library which may be used for learning; output the inferred global context to one or more AI agents to be used for decision-making; use the inferred global context for decision-making and task-formulating, and output them as instructions to one or more AI agents. The global context generator 150 may, for example, be a second in-context learning computation model such as a large language model (LLM). In addition, the conflict handler 140 may output predicted missing context or gaps in the context of one or more AI agents and/or predicted missing token or gaps in input prompts from the local context coordinators 121, 122 and/or to the global context generator 150, based on the received observed and predicted states, metadata and other data.

FIG. 2 shows schematically an exemplary data flow of an embodiment of a conflict handler, such as the conflict handler 140. As described above with reference to FIG. 1, the conflict handler 140 receives various inputs 210 including normalized context data and metadata from each AI agent, vectors of each AI agent's observations and predictions, a vector of each AI agent's action, a matrix of cross knowledge, one or more contextual databases, and one or more learning models. Vectors are mathematical representations of data that AI agents use to understand, process, and retrieve information. The matrix of cross knowledge may include e.g. data indicating that two or more AI agents are working in a joint scenario, data indicating that Agent n is in the vicinity of Agent 1, in which case the conflict handler 140 may use the context received from Agent 1 to infer a context input for Agent n, and the inferred context may be used to validate or invalidate the observed and predicted states transmitted from Agent n, etc.

Using the received input 210, the conflict handler 140 generates various scores for each AI agent, including, for example, a real time novelty distance of observed context, a real time novelty distance of predicted context, a novelty difference of observed context, a short-term context score, a long-term context score, and an overall context score. In the present embodiment, the conflict handler 140 may determine the scores as such:

Real time Novelty Distance (RND)

$$RND ( S \{ t \} ) = ‖ ⊙ ( S \{ t \} ) - ⊙ ( S \{ t + 1 \} ) ‖$$

gives a measure of the novelty state of the real time context representation provided by a given AI agent, and

$${RND}^{′} ( S \{ t \} ) = ‖ ⊙ ( S \{ t \} ) - {⊙}^{′} ( S \{ t \} ) ‖$$

gives a measure of the novelty state of the context predicted by a given AI agent,
where ⊙ denotes a neural network encoder, which produces an embedding of observation and/or context inferred by a given AI agent.

### Novelty DIFFERENCE (ND)

$$ND ( S \{ t \} ; S \{ t + 1 \} ) = RND ( S \{ t + 1 \} ) - RND ( S \{ t \} )$$

### Context Short Term (CST)

$$C S T ( S \{ t \} , S \{ t + 1 \} ) = max ( RND ( S \{ t + 1 \} ) - RND ( S \{ t \} ) )$$

$${CST}^{′} ( S \{ t \} , {S}^{′} \{ t \} ) = max ( RND ( {S}^{′} \{ t \} ) - RND ( S \{ t \} ) )$$

### Context Life-Long History (CLLH)

$$CLLH ( S \{ t \} , S \{ t + 1 \} ) = max ( RND ( S \{ t + 1 \} ) - ARND ( S \{ t \} ) )$$

$${CLLH}^{′} ( S \{ t \} , {S}^{′} \{ t \} ) = max ( RND ( {S}^{′} \{ {t}^{′} \} ) - ARND ( S \{ t \} ) )$$

where ARND (S{t}) is the average Real time Novelty Distance of a state S at instant t.
   Context Conflict Handler score (CCH)

$$C C H ( S \{ t \} , S \{ t + 1 \} ) = C L L H ( S \{ t \} , S \{ t + 1 \} ) \times CST ( S \{ t \} , S \{ t + 1 \} )$$

$$CCH ( S \{ t \} , {S}^{′} \{ t \} ) = C L L H ( S \{ t \} , {S}^{′} \{ t \} ) \times CST ( S \{ t \} , {S}^{′} \{ t \} )$$

Typically, a higher CST score indicates that the AI agent's context is transitioning quickly to a different context case, while a higher CST′ score indicates that the AI agent's context is predicted to transition quickly to a different context case. On the other hand, a higher CLLH score indicates that the AI agent's context is diverging from a normal (known) case towards a corner case, while a higher CLLH′ score indicates that the AI agent's context is predicted to diverge from a normal (known) case towards a corner case.

The conflict handler 140 is configured to output a set of conditions 220 to be used as input prompts for the global context generator 150 (e.g. an LLM), including an overall context score CCH for each AI agent. Moreover, the conflict handler 140 may identify one or more AI agents with a divergence between their CST and CST′ and/or a divergence between their CLLH and CLLH′, which indicates that the AI agents are not behaving as predicted. Moreover, the conflict handler 140 may identify a group of AI agents that show sudden changes in CST, CLLH and/or CCH, and a group of AI agents with stable context (i.e. no sudden changes in CST, CLLH and CCH), and these data may be used as prompts for the global context generator 150 to understand the differences between the groups. Further, if the metadata of an AI agent indicates its capability (e.g. camera resolution and range, audio resolution and range, processing speed and accuracy, etc.), a weight for the context transmitted from the AI agent may be determined—for example, higher weight for higher capability such that the context from the AI agent is prioritized. The metadata may also be used by the conflict handler 140 to determine or estimate the reliability of the AI agent, for example, whether the AI agent has any past security issues that may compromise the reliability of its context.

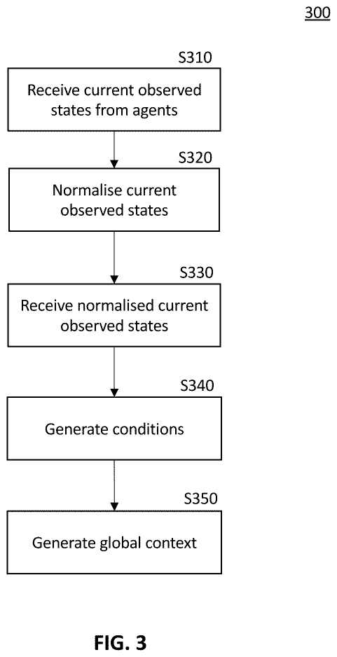

FIG. 3 shows a flow diagram of an exemplary method of consolidating local context into global context for a system comprising a plurality of AI agents. The method 300 begins at S310, when a local context coordinator, such as the local context coordinators 121, 122, receives from the plurality of AI agents a current observed state (e.g. S1{t}, S2{t}, Sn{t}) representative of a current local environment of each AI agent.

Then, at S320, the local context coordinator normalizes the received current observed state to a common form. In doing so, it is not necessary for the plurality of AI agents to have the same semantic and ontology to achieve context awareness across all AI agents. The implementation of the local context coordinator allows a dynamic and robust ontology built, in dynamic environments where new and uncertain rules and/or patterns are constantly emerging. As an example, in embodiments where the local context coordinator is an LLM, ontology standardization may be replaced by LLM prompts.

At S330, a conflict handler, such as the conflict handler 140, receives the current normalised observed states (e.g. local contexts 131, 132, 133) from the local context coordinator. Then, at S340, the conflict handler generates a set of conditions based on the current normalised observed states, for example as described with reference to FIG. 2.

As S350, a global context generator, such as the global context generator 150, receives the set of conditions, and generates an integrated (global) context representative of a global environment that comprises the respective current local environment of the plurality of AI agents.

In some embodiment, generating a set of conditions may comprise the conflict handler determining a divergence between the current normalised observed states and respective previous normalised observed states (S1{t−1}, S2{t−1}, Sn{t−1}).

In some embodiments, the method 300 may further comprise the local context coordinator receiving from each AI agent a current predicted state (S1′{t}, S2′{t}, Sn′{t}) of the respective local environment generated based on a previous observed state (S1{t−1}, S2{t−1}, Sn{t−1}), normalising the current predicted state from each AI agent, and the conflict handler generating the set of conditions based on a divergence between the current normalised observed states and respective current normalised predicted states.

In some embodiments, generating a set of conditions may comprise the conflict handler determining a divergence between the current normalised predicted states and respective previous normalised predicted states (S1′{t−1}, S2′{t−1}, Sn′{t−1}).

In some embodiments, the method 300 may further comprise the conflict handler receiving metadata from one or more AI agents, and generating the set of conditions based on the metadata respective of each AI agent.

In some embodiments, the method 300 may further comprise the conflict handler determining a weight with respect to a normalised observed state received from an AI agent by using the metadata respective of the AI agent.

In some embodiments, the method 300 may further comprise the conflict handler validating the current normalised observed state of a second AI agent by using the current normalised observed state of a first AI agent, the metadata of the first AI agent, and the metadata of the second AI agent.

Thus, according to the embodiments, the conflict handler is able to perform causality retrieval, then the global context generator (e.g. a second LLM) is used to infer the global context and potential consequences. Moreover, the conflict handler is able to create a library of variations, context and observation at runtime, and, together with the global context generator, is able to identify gaps in the capability and reliability/trustworthiness of each AI agent when inferring global context. For example, a gap between the type (and therefore capability) of cameras used by different AI agents may, e.g., be addressed by assigning a weight to the context transmitted by the AI agents.

The following gives a brief overview of a number of different types of machine learning algorithms for embodiment(s) in which one or more MLAs are used. However, it should be noted that the use of an MLA in these embodiment(s) is a non-limiting example of implementing the present technology, and the use of an MLA is not essential.

### Overview of MLAs

There are many different types of MLAs known in the art. Broadly speaking, there are three types of MLAs: supervised learning-based MLAs, unsupervised learning-based MLAs, and reinforcement learning-based MLAs.

Supervised learning MLA process is based on a target-outcome variable (or dependent variable), which is to be predicted from a given set of predictors (independent variables). Using this set of variables, the MLA generates a function using training data that maps inputs to desired outputs during training. The training process continues until the MLA achieves a desired level of accuracy on validation data. Examples of supervised learning-based MLAs include: Regression, Decision Tree, Random Forest, Logistic Regression, etc.

Unsupervised learning MLA does not involve predicting a target or outcome variable but learns patterns from untagged data. Such MLAs are capable of self-organization to capture patterns as probability densities, and are used e.g. for clustering a population of values into different groups. Clustering is used in many fields including pattern recognition, image analysis, bioinformatics, data compression, computer graphics, etc. Examples of unsupervised learning MLAs include: apriori algorithm and k-means algorithm.

Reinforcement learning MLA is trained to take actions or make decisions that maximize cumulative reward (e.g. a user-provided score). During training, the MLA is exposed to a training environment where it learns through trial and error to develop an optimal or near-optimal policy that maximizes reward. In doing so, the MLA learns from past experience and attempts to capture the best possible knowledge to make desirable decisions. An example of reinforcement learning MLA is a Markov Decision Process.

It should be understood that different types of MLAs having different structures or topologies may be used for various tasks. One particular type of MLAs includes artificial neural networks (ANN), also known as neural networks (NN).

### Neural Networks (NN)

Generally speaking, a given NN consists of an interconnected group of artificial “neurons”, which process information using a connectionist approach to computation. NNs are used to model complex relationships between inputs and outputs (without actually knowing the relationships) or to find patterns in data. NNs are first conditioned in a training phase in which they are provided with a known set of “inputs” and information for adapting the NN to generate appropriate outputs (for a given situation that is being attempted to be modelled). During this training phase, the given NN adapts to the situation being learned and changes its structure such that the given NN will be able to provide reasonable predicted outputs for given inputs in a new situation (based on what was learned). Thus, rather than attempting to determine a complex statistical arrangements or mathematical algorithms for a given situation, the given NN aims to provide an “intuitive” answer based on a “feeling” for a situation. The given NN is thus regarded as a trained “black box”, which can be used to determine a reasonable answer to a given set of inputs in a situation giving little importance to what happens inside the “box”.

NNs are commonly used in many such situations where an appropriate output based on a given input is important, but exactly how that output is derived is of lesser importance or is unimportant. For example, NNs are commonly used to optimize the distribution of web-traffic between servers and in data processing, including filtering, clustering, signal separation, compression, vector generation and the like.

### Deep Neural Networks

In some non-limiting embodiments of the present technology, the NN can be implemented as a deep neural network. It should be understood that NNs can be classified into various classes of NNs. Below are a few non-limiting example classes of NNs.

### Recurrent Neural Networks (RNNs)

RNNs are adapted to use their “internal states” (stored memory) to process sequences of inputs. This makes RNNs well-suited for tasks such as unsegmented handwriting recognition and speech recognition, for example. These internal states of the RNNs can be controlled and are referred to as “gated” states or “gated” memories.

It should also be noted that RNNs themselves can also be classified into various sub-classes of RNNs. For example, RNNs comprise Long Short-Term Memory (LSTM) networks, Gated Recurrent Units (GRUs), Bidirectional RNNs (BRNNs), and the like.

LSTM networks are deep learning systems that can learn tasks that require, in a sense, “memories” of events that happened during very short and discrete time steps earlier. Topologies of LSTM networks can vary based on specific tasks that they “learn” to perform. For example, LSTM networks may learn to perform tasks where relatively long delays occur between events or where events occur together at low and at high frequencies. RNNs having particular gated mechanisms are referred to as GRUs. Unlike LSTM networks, GRUs lack “output gates” and, therefore, have fewer parameters than LSTM networks. BRNNs may have “hidden layers” of neurons that are connected in opposite directions which may allow using information from past as well as future states.

### Residual Neural Network (ResNet)

Another example of the NN that can be used to implement non-limiting embodiments of the present technology is a residual neural network (ResNet).

Deep networks naturally integrate low/mid/high-level features and classifiers in an end-to-end multilayer fashion, and the “levels” of features can be enriched by the number of stacked layers (depth).

### Convolutional Neural Network (CNN)

CNNs are also known as shift invariant or space invariant artificial neural networks (SIANN), based on the shared-weight architecture of the convolution kernels or filters that slide along input features and provide translation equivariant responses known as feature maps. They are most commonly applied to analyze visual imagery and have applications in image and video recognition, recommender systems, image classification, image segmentation, medical image analysis, natural language processing, brain-computer interfaces, and financial time series.

CNNs are regularized fully connected networks, that is, each neuron in one layer is connected to all neurons in the next layer. CNNs use relatively little pre-processing compared to other image classification algorithms and learn to optimize the filters (or kernels) through automated learning.

To summarize, the implementation of at least a portion of the one or more MLAs in the context of the present technology can be broadly categorized into two phases—a training phase and an in-use or deployed phase. First, the given MLA is trained in the training phase using one or more appropriate training data sets. Then, once the given MLA learned what data to expect as inputs and what data to provide as outputs, the given MLA is executed using in-use data in the in-use or deployed phase. Further, while deployed, the given MLA may continue to learn from the in-use data based for example on user feedback.

The various MLAs described above may refer to the same or different MLA. If multiple MLAs are implemented, one or some or all of the MLAs may be executed on the device, and one or some or all of the MLAs may be executed on a server (e.g. a cloud server) in communication with the device via a suitable communication channel. It will be understood by those skilled in the art that the embodiments above may be implemented in any combinations, in parallel or as alternative strategies as desired.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

What is claimed is:

1. A system for constructing global context from a plurality of artificial intelligence, AI, agents (111, 112, 113), comprising:
a local context coordinator (121, 122) to communicate with the plurality of AI agents, to receive from one or more of the plurality of AI agents a current observed state (S1{t}, S2{t}, Sn{t}) representative of a current local environment of each AI agent, and to normalise the current observed state to a common form;
a conflict handler (140) to receive the current normalised observed states (131, 132, 133) from the local context coordinator and generate a set of conditions based on the current normalised observed states; and
a global context generator (150) to receive the set of conditions and generate an integrated context (160) representative of a global environment comprising the respective current local environment of the plurality of AI agents.

2. The system of claim 1, wherein the conflict handler is configured to generate the set of conditions based on a divergence between the current normalised observed states and respective previous normalised observed states (S1{t−1}, S2{t−1}, Sn{t−1}).

3. The system of claim 2, wherein the conflict handler is configured to identify one or more AI agents with high divergence between the current normalised observed states and respective previous normalised observed states.

4. The system of claim 1, wherein each AI agent is configured to output a current predicted state (S1′{t}, S2′{t}, Sn′{t}) of the respective local environment based on a previous observed state (S1{t−1}, S2{t−1}, Sn{t−1}), the local context coordinator is configured to normalise the current predicted state from each AI agent, and the conflict handler is configured to generate the set of conditions based on a divergence between the current normalised observed states and respective current normalised predicted states.

5. The system of claim 4, wherein the conflict handler is configured to identify one or more AI agents with high divergence between the current normalised observed states and respective current normalised predicted states.

6. The system of claim 4, wherein the conflict handler is configured to generate the set of conditions based on a divergence between the current normalised predicted states and respective previous normalised predicted states (S1′{t−1}, S2′{t−1}, Sn′{t−1}).

7. The system of claim 6, wherein the conflict handler is configured to identify one or more AI agents with high divergence between the current normalised predicted states and respective previous normalised predicted states.

8. The system of claim 1, wherein the conflict handler is configured to receive metadata from one or more AI agents and generate the set of conditions based on the metadata respective of each AI agent.

9. The system of claim 8, wherein the conflict handler is configured to use the metadata respective of an AI agent to determine a weight with respect to a normalised observed state received from the AI agent.

10. The system of claim 8, wherein the conflict handler is configured to use the current normalised observed state of a first AI agent, the metadata of the first AI agent, and the metadata of a second AI agent, to validate the current normalised observed state of the second AI agent.

11. The system of claim 8, wherein the metadata comprises a location of the AI agent, a capability of the AI agent, one or more hardware characteristics, one or more software characteristics, or a combination thereof.

12. The system of claim 1, wherein the global context generator is configured to use the generated integrated context to output an instruction to at least one of the plurality of AI agents to perform an action.

13. The system of claim 1, wherein the global context generator is an in-context learning computation model and the set of conditions comprises one or more input prompts.

14. A computer-implemented method of constructing global context for a system comprising a plurality of artificial intelligence, AI, agents, the method comprising:
receiving, by a local context coordinator, from one or more of the plurality of AI agents a current observed state (S1{t}, S2{t}, Sn{t}) representative of a current local environment of each AI agent;
normalising, by the local context coordinator, the received current observed state to a common form;
receiving, by a conflict handler, the current normalised observed states (131, 132, 133) from the local context coordinator;
generating, by the conflict handler, a set of conditions based on the current normalised observed states;
receiving, by a global context generator, the set of conditions; and
generating, by the global context generator, an integrated context representative of a global environment comprising the respective current local environment of the plurality of AI agents.

15. The method of claim 14, wherein generating a set of conditions comprises the conflict handler determining a divergence between the current normalised observed states and respective previous normalised observed states (S1{t−1}, S2{t−1}, Sn{t−1}).

16. The method of claim 14, further comprising:
receiving, by the local context coordinator, from each AI agent a current predicted state (S1′{t}, S2′{t}, Sn′{t}) of the respective local environment generated based on a previous observed state (S1{t−1}, S2{t−1}, Sn{t−1});
normalising, by the local context coordinator, the current predicted state from each AI agent; and
generating, by the conflict handler, the set of conditions based on a divergence between the current normalised observed states and respective current normalised predicted states.

17. The method of claim 16, wherein generating a set of conditions comprises the conflict handler determining a divergence between the current normalised predicted states and respective previous normalised predicted states (S1′{t−1}, S2′{t−1}, Sn′{t−1}).

18. The method of claim 14, further comprising:
receiving, by the conflict handler, metadata from one or more AI agents; and
generating, by the conflict handler, the set of conditions based on the metadata respective of each AI agent.

19. The method of claim 18, further comprising determining, by the conflict handler, a weight with respect to a normalised observed state received from an AI agent by using the metadata respective of the AI agent.

20. The method of claim 18, further comprising validating, by the conflict handler, the current normalised observed state of a second AI agent by using the current normalised observed state of a first AI agent, the metadata of the first AI agent, and the metadata of the second AI agent.
